(19) United States
(12) Patent Application Publication
(10) Pub. No.: US 2014/0237627 A1
(43) Pub. Date: Aug. 21, 2014

(54) PROTECTING DATA IN A MOBILE ENVIRONMENT

(71) Applicant: Marble Security, Sunnyvale, CA (US)

(72) Inventor: Ramana M. Mylavarapu, San Jose, CA (US)

(21) Appl. No.: 13/942,598

(22) Filed: Jul. 15, 2013

Related U.S. Application Data
(60) Provisional application No. 61/766,619, filed on Feb. 19, 2013.
(60) Provisional application No. 61/824,931, filed on May 17, 2013.

(51) Int. Cl. G06F 21/60

(52) U.S. Cl. CPC G06F 21/60
USPC 726/30

(57) ABSTRACT

A system for protecting data in a mobile environment is described. According to the system, a mobile device transmits first data to a server. The mobile device receives second data from the server that is responsive to the first data. The mobile device uses the received second data, together with third data stored on the mobile device, to decrypt fourth data stored in encrypted form on the mobile device. Prior to receiving the second data, the state of the mobile device is inadequate to decrypt the fourth data.

### CROSS-REFERENCE TO RELATED APPLICATION(S)

This application claims the benefit of U.S. Provisional Patent Application No's. 61/766,619, filed Feb. 19, 2013, entitled “MOBILE DEVICE SECURITY TECHNIQUES,” (Attorney Docket 88522-8001.US00) and U.S. Provisional Patent Application No. 61/824,931, filed May 17, 2013, entitled “PROTECTING DATA IN A MOBILE ENVIRONMENT,” (Attorney Docket 88522-8002.US00), each of which is incorporated herein by reference in its entirety.

### TECHNICAL FIELD

The described technology is directed to the field of computer security.

### BACKGROUND

It has become common for information workers, who often work with valuable and sensitive data, to access such data using mobile devices, such as smartphones, tablets, and laptop computers. In some cases such mobile devices are owned and/or controlled to some extent by the workers' employers, but in many cases they are not.

### BRIEF DESCRIPTION OF THE DRAWINGS

FIG. 1 is a network diagram showing a typical environment in which the system operates.

FIG. 2 is a block diagram showing some of the components typically incorporated in at least some of the computer systems and other devices on which the system operates.

FIG. 3A-3B together comprise a flow diagram showing steps performed by the system in some environments to perform a ClientStartup routine.

FIGS. 4A-4D together comprise a flow diagram showing steps typically performed by the system in order to perform either of two routines: the UserActivation routine and the AccountReactivationFromNewDevice routine.

FIGS. 5A-5D collectively comprise a flow diagram showing steps typically performed by the system in order to perform the UserLogin routine.

FIG. 6A-6D collectively comprise a flow diagram showing steps typically performed by the system in order to perform an AccountReactivationFromAddedDevice routine.

FIGS. 7A-7D together comprise a flow diagram showing steps typically performed by the system as part of performing an AddDevice routine.

### DETAILED DESCRIPTION

The inventors have recognized that mobile devices, when used in conventional manners—especially those not owned and controlled by an organization that has significant data security resources—have significant security vulnerabilities that can expose data accessed via mobile devices to theft, alteration, and destruction. A number of such vulnerabilities are outlined in U.S. Provisional Patent Application No. 61/766,619 filed on Feb. 19, 2013, which is hereby incorporated by reference in its entirety.

For example, it is common to send data either in plaintext, or in an Secure Sockets Layer (“SSL”) session encrypted with a key that is common across potentially large groups of users and/or sessions. In cases where the key varies across users, it is frequently based in a predictable manner on a hardware identifier of the device. All such keys are often invariant over time.

Accordingly, the inventors have designed a security system (“the system”) that protects data while stored, transmitted, and processed in a mobile environment from theft, alteration, and destruction. In some embodiments, the data protected by the system includes encryption keys, configurations, user policies, user preferences, identity bindings, data entered by the user, and data generated by a mobile application. In some embodiments, the data protected by the system includes code, such as the code of a mobile application that constitutes an operational part of the system.

In some embodiments, the system requires a user to input a single-use activation code provided by the operator the system in order to register to use the system.

In some embodiments, the system both uses SSL connections for all communications between the client and server, and separately encrypts the payload sent via these SSL connections. In some embodiments, the separate encryption is performed using a key that varies across both user identity and time. In some embodiments, this key is not based on any permanently encoded identifier of the client.

In some embodiments, the system encrypts data stored on the client. In some embodiments, the key needed to decrypt the data stored on the client is not stored persistently on the client, even in an encrypted form. In some embodiments, the key needed to decrypt the data stored on the client is never possessed by the server in unencrypted form. Rather, as part of each instance in which the application is executed on the client, the client regenerates this key based on interactions with the server. In some embodiments, these interactions are based upon authentication of the user to the service, and/or provision of a device certificate stored on the client. In some embodiments, these interactions can only occur after the application successfully interact with the server to perform a trustedness assessment of the client. In various embodiments, this trustedness assessment involves various aspects, including comparison of client characteristics (such as manufacturer model, operating system) to sets of characteristics known to have trustedness issues; a malware scan of the client; other programmatic analysis of the client, programs installed on it, the configuration of those programs, data stored on it, the networks it connects to, etc.

By operating in some or all of the ways described above, the system tends to reduce the probability that attacks of a variety of types including the following will succeed: off-line brute force attacks, man-in-the-middle attacks, information tampering, and information theft.

In general, when the following terms are used herein, they have the following meaning:

| | |
|---|---|
| 1. | Device: mobile device |
| 2. | User: user of mobile device |
| 3. | Client, Application, Client Application, App: security app installed on mobile |
| | device |
| 4. | Service: server- and/or cloud-implemented security service |
| 5. | EmbeddedEncryptionKey: Random String common to all devices, AES256 |
| | Encrypted by Service. This code is embedded in the Client Application or part of |
| | client manifest/configuration file. |
| 6. | DeviceSpecificEncryptionKey: It binds DeviceID to user LoignID. It contains |
| | {LoginID, DeviceID}, AES256 encrypted by ServiceSecret. Service issues it to the |
| | Client after successful activation of a device. Client uses this code in subsequent |
| | login activity. This code is stored outside of the application unencrypted. |
| 7. | LoginID: User LoginID (email address as provisioned in Service) |
| 8. | DeviceID: Unique Device Identifier as provided by device manufacturer. Client |
| | Application queries it from the Device using device specific API. |
| 9. | UniqueActivationCode/TemporaryPassword: A text string that is provided to the |
| | user for the purpose of signing up the service first time through Client Application. |
| 10. | ApplicationSignature: Signature of Client application on the device. |
| 11. | ApplicationDataChecksum: Checksum of Client application data on the device. |
| 12. | ServiceSecret: An AES256 Encryption Key generated by Service. It is unique to |
| | every user device. It is generated once during device activation flow and remains |
| | same. It gets regenerated if a device is reactivated on request of the user (change |
| | password/forgot password). |
| 13. | ServiceSessionKey: An AES256 Encryption Key generated by Service. It is |
| | unique to a given flow (activation, login, etc). This key is communicated one in a |
| | given flow to the Client through an encrypted message that the Client can only |
| | decrypt the message and get the ServiceSessionKey. Subsequently any |
| | information that exchanged between Service and Client both-ways are always |
| | encrypted using ServiceSessionKey along with a valid ClientBinding. |
| 14. | ClientBinding: A binding that is issued by Service unique to every transaction. |
| | ClientBinding is encrypted result of ServiceSecret{LoginID, DeviceIPAddress, |
| | DeviceID, SessionID, TimeStamp, SequenceNumber}. The ClientBinding can be |
| | decrypted only by the Service since it is encrypted using ServiceSecret of a |
| | device. |
| | Where, |
| | TimeStamp = System timestamp with Date/Time. |
| | SequenceNumber = Unique to every message from Service to Client. |
| | The Service adds the ClientBindings to inactivity timer list, if there is no response |
| | received within its inactivity interval, then that ClientBinding it will be timedout and |
| | deleted from the system. Any response that is received subsequently is treated |
| | as a stale response and gets discarded. |
| | After a response received from Client, the ClientBinding is invalidated and hence |
| | replay attacks by using ClientBinding are prevented and detected. |
| | A ClientBinding issued to a device is not reusable by any other device or spoofed |
| | device since it is bound to Device and its network IP address. |
| 15. | TimeStamp: System timestamp with Date/Time. |
| 16. | SequenceNumber: It is an ascending numeric value that the Service sends to the |
| | Client in the user authentication flows. |
| 17. | TransactionSalt: It is a Salt that is used in hashing temporary password and |
| | password. |
| 18. | Salt: It is a random data that is used as an additional input to a one-way function |
| | that hashes temporary password or password. |
| 19. | Nonce: a unique random String issued by Service every time it challenges the |
| | user for password authentication. |
| 20. | NonceCount: The number of times the client has sent a challenge response by |
| | using above Nonce. |
| 21. | DevicePrivateKey: RSA1024 Private Key of the device that is generated by the |
| | device. This key is stored in encrypted form on the device using |
| | CertPKEncryptionKey. |
| 22. | DevicePublicKey: RSA1024 Private Key of the device that is generated by the |
| | device. This key is stored along with DeviceCert in encrypted form on the device |
| | using CertPKEncryptionKey. |
| 23. | DeviceCert: .CRT and DevicePublicKey of the device generated by Client. |
| 24. | CertPKEncryptionKey: AES 256 Encryption Key generated by Service for |
| | encrypting Device's Certificate and Private Key. |
| 25. | DefaultPolicy: A device policy that is issued by Service to the Client. |
| 26. | DataEncryptionKey: An AES256 encryption key for encrypting data on the device. |
| | This key is unique to a device and data of that device can only be decrypted using |
| | this key upon successful login of the user with Service. |
| 27. | RSAEncryptedDataEncryptionKey: DataEncryptionKey that is encrypted using |
| | DevicePrivateKey sent to Service to store. |
| 28. | AESEncryptedDataEncryptionKey: DataEncryptionKey that AES encrypted using |
| | PSH1 of the user password and sent to Service to store. The Client can get |
| | either RSAEncryptedDataEncryptionKey or AESEncryptedDataEncryptionKey as |
| | the case may be (as decided by Service in the login/password reset flows). |
| 29. | CSR: A message sent from an applicant to a Certificate Authority in Service in |
| | order to apply for a digital identity certificate, sent in PKCS#10 format. |
| 30. | PSH1: Password+Salt&hash |
| 31. | PSH2: PSH1+Salt&hash |
| 32. | PSH3: PSH2+Salt&hash |
| 33. | User Data: Data that may be protected by encryption using the data encryption |
| | key, including: |

| | |
|---|---|
| i. | The data such as policy updates, book-marks, browser cache by Application. |
| ii. | Other applications on the device that use data encryption keys to secure |
| | the data. |
| iii. | Protecting workspace container data of all applications running in the |
| | container by making use of virtualization services of the device |

| | |
|---|---|
| 34. | Notation for Encryption: A notation of A{B} indicates that B is encrypted with key |
| | A. |

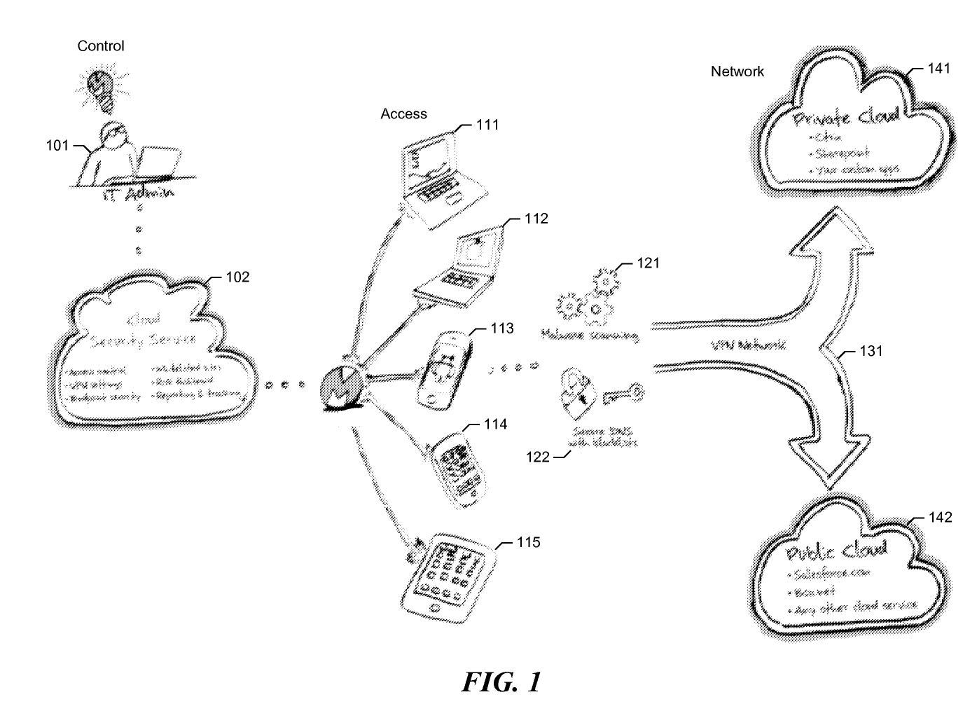

FIG. 1 is a network diagram showing a typical environment in which the system operates. An administrator 101 interacts with a cloud security service to configure and control it. In various embodiments, the service provides access control, VPN settings, end point security, whitelisted sites, at risk-dashboard, and reporting and tracking, among other security features. The security service interacts with a number of wired and wireless client devices 111-115. For these client devices, the service provides such functionality as malware scanning 121 and secured DNS with blacklist 122. A VPN network 131 provides access both to a private cloud operated by the organization with whose client devices the service is used, and a public cloud including online applications operated by independent service providers on behalf of many customer. The system secures data stored on the client devices, as well as its transmission between the client devices and the security service, the private cloud, and the public cloud.

While various embodiments are described in terms of the environment described above, those skilled in the art will appreciate that the system may be implemented in a variety of other environments including a single, monolithic computer system, as well as various other combinations of computer systems or similar devices connected in various ways. In various embodiments, a variety of computing systems or other different client devices may be used in place of the web client computer systems, such as mobile phones, personal digital assistants, televisions, cameras, etc.

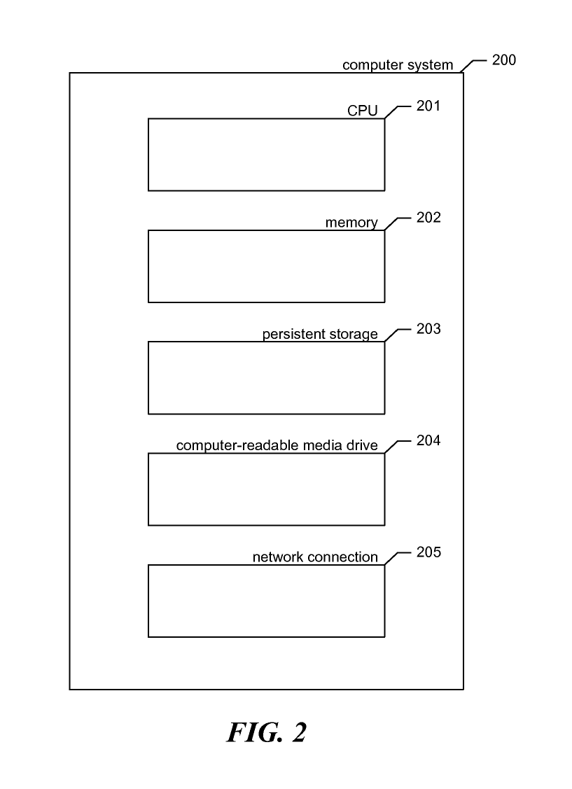

FIG. 2 is a block diagram showing some of the components typically incorporated in at least some of the computer systems and other devices on which the system operates. In various embodiments, these computer systems and other devices 200 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 201 for executing computer programs; a computer memory 202 for storing programs and data while they are being used, including the programs that comprise part of the system and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the system, those skilled in the art will appreciate that the system may be implemented using devices of various types and configurations, and having various components.

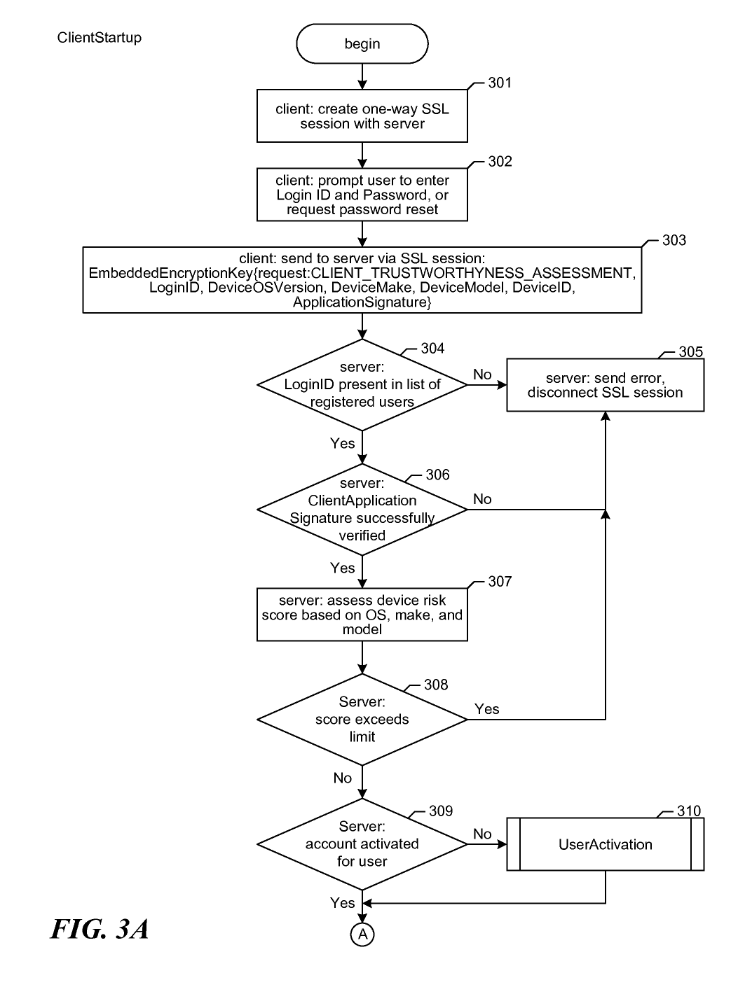

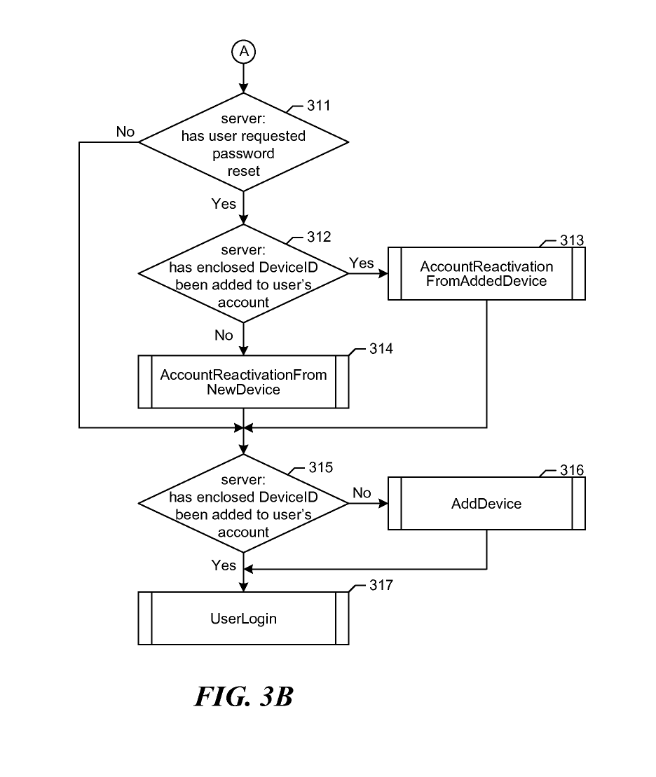

FIG. 3A-3B together comprise a flow diagram showing steps performed by the system in some environments to perform a ClientStartup routine. The system generally performs this routine when the security application is launched on the client device. In some embodiments, the security application can be configured to launch automatically each time the device starts.

In step 301, the client, under the control of the client application, creates a one-way SSL session with the server. In step 302, the client prompts the user to enter a LoginID and password. In some embodiments, if the user does not know his or her password, the user can instead request a password reset. In some embodiments, where the user requests a password reset, the system jumps to step 311. In step 303, the client encrypts a request to make a client trustworthy in this assessment that specifies the following information with an EmbeddedEncryptionKey: the user's LoginID; the make, model, and operating system version of the device; an identifier of the device, and a signature for the application. In step 304, if the LoginID specified in the request sent in step 303 is in a list of registered users, then the server continues in step 306, else the server continues in step 305. In step 305, the sever sends an error message to the client and disconnects the SSL session. These steps then conclude.

In step 306, if the server can successfully verify the ClientApplicationSignature specified in the request, then the server continues in step 307, else the server continues in step 305. In step 307, the server assesses a device risk score for the device based upon the operating system, make, and model specified for the device and the request. In step 308, if the score assessed in step 307 exceeds a risk score limit, then the server continues in step 305, else the server continues in step 309. In 309, if the user identified by the LoginID specified in the request is already activated, then the system continues via connector A to step 311, else the server continues in step 310. In step 310, the system calls a UserActivation routine described below.

In step 311, if the user has requested a password reset in step 302, then the server continues in step 312, else the server continues in step 315. In step 312, if the DeviceID specified in the request has previously been added to the user's account, then the server continues in step 313, else the server continues in step 314. In step 313, the system executes an AccountReactivationFromAddedDevice routine described below. After step 313, the system continues in step 315.

In step 314, the system executes an AccountReactivationFromNewDevice routine described below. After step 314, the system continues in step 315. In step 315, if the DeviceID specified in the request has been added to the user's account, then the server continues in step 317, else the server continues in step 316. In step 316, the system executes an AddDevice routine described below. After step 316, the system continues in step 317. In step 317, the system executes a UserLogin routine described below. After step 317, these steps conclude.

Those skilled in the art will appreciate that the steps shown in FIG. 3 and in each of the flow diagrams discussed below may be altered in a variety of ways. For example, the order of the steps may be rearranged; some steps may be performed in parallel; shown steps may be omitted, or other steps may be included; a shown step may be divided into substeps, or multiple shown steps may be combined into a single step, etc.

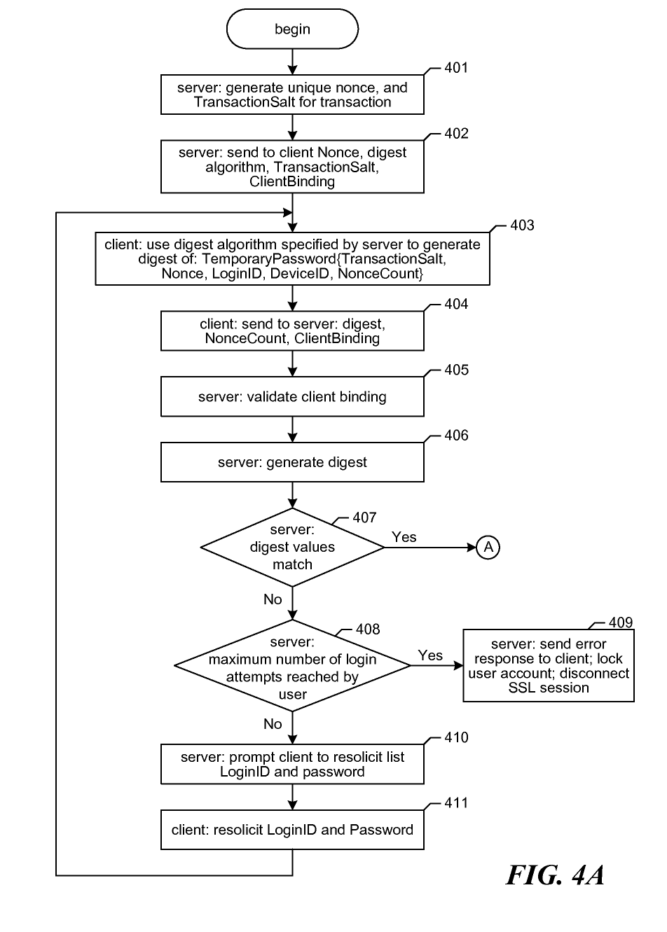

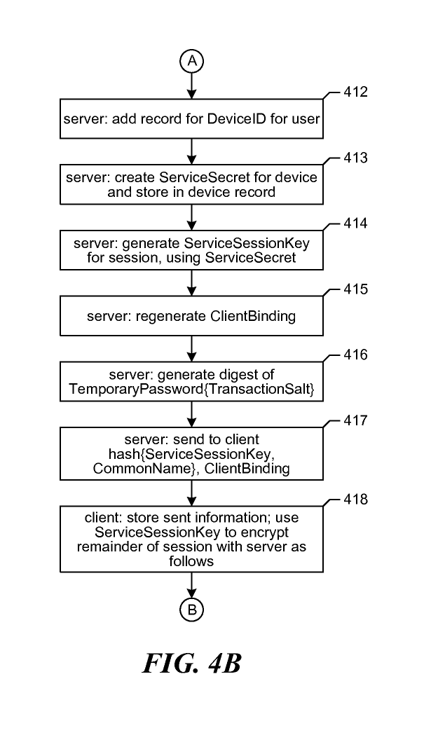

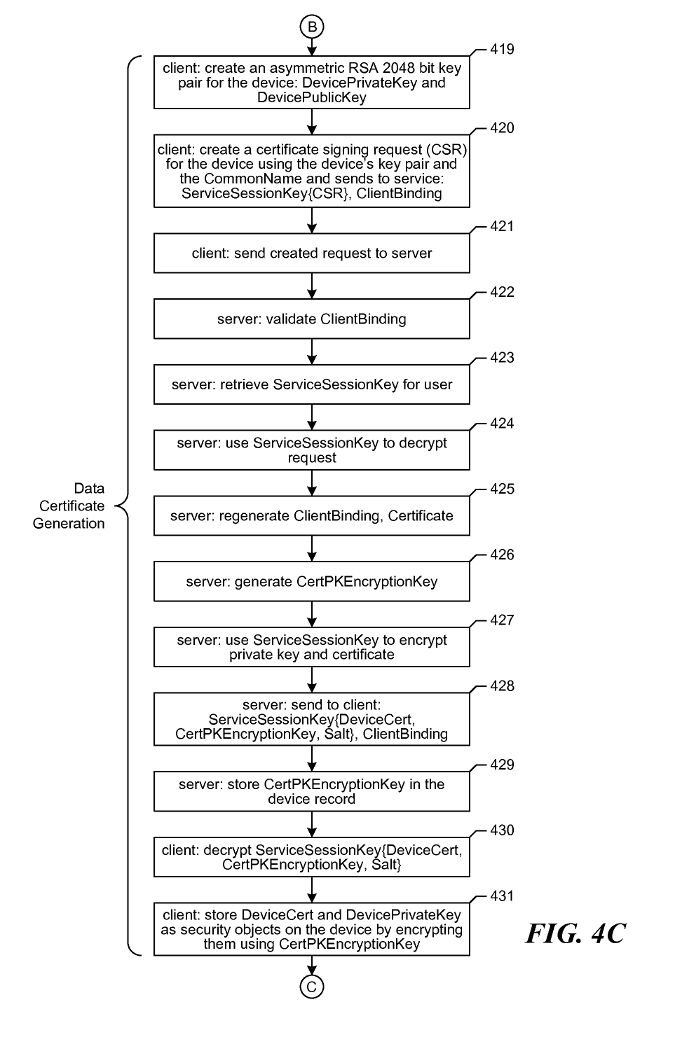

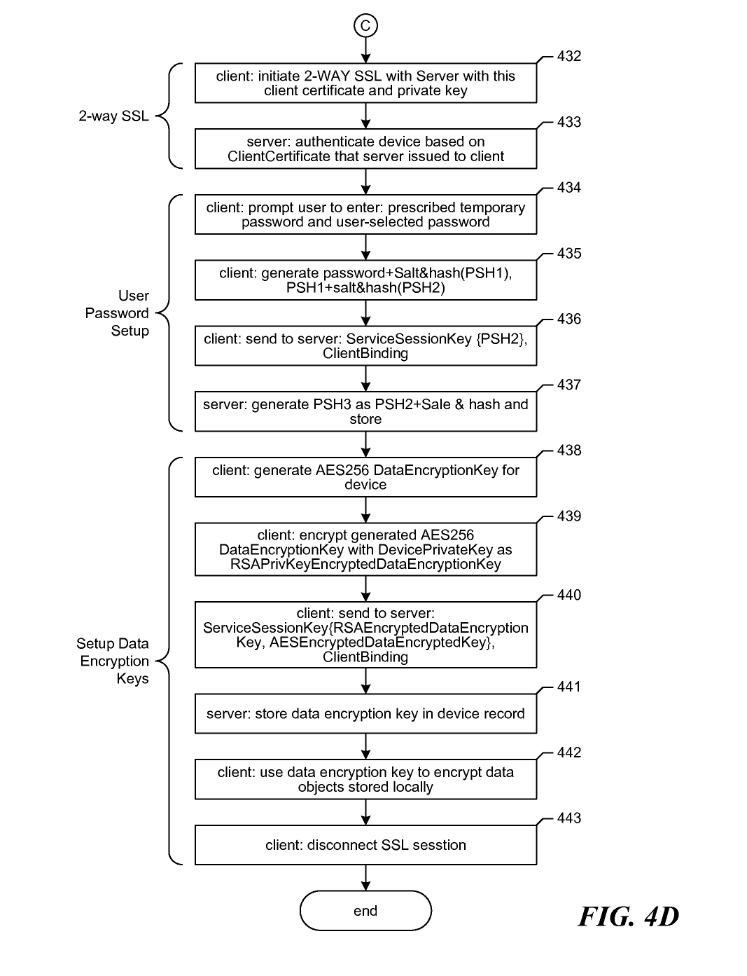

FIGS. 4A-4D together comprise a flow diagram showing steps typically performed by the system in order to perform either of two routines: the UserActivation routine and the AccountReactivationFromNewDevice routine. In step 401, the server generates a unique Nonce, as well as a hashing Salt for the upcoming transaction. In step 402, the server sends to the client the Nonce, the identity of a digest algorithm to be used to produce digest values, the Salt, and a ClientBinding. In step 401, upon receiving the information sent in step 402, the client uses the digest algorithm specified by the server to generate a digest of the Salt, Nonce, LoginID, DeviceID, and NonceCount, all encrypted using a temporary password specified initially to the user by the operator of the system as a single-use activation code. In step 404, the client sends to the server the digest generator in step 403 along with the NonceCount and ClientBinding. In step 405, the server, upon receiving the information sent by the client in step 404, validates the ClientBinding. In step 406, the server performs the same process used by the client in step 403 to generate a digest for the encrypted elements listed there. In step 407, if the digest value generated in step 406 matches the one generated in step 403, then the server continues through a connector A to step 412, else the server continues in step 408. In step 408, if the maximum number of login attempts has been reached by the user, then the server continues in step 409, else the server continues in step 410. In step 409, the server sends an error response to the client, locks the user account so that it cannot be used, and disconnects the SSL session that is in progress. After step 409, these steps conclude.

In step 410, the server prompts the client to resolicit a LoginID and password from the user. In step 411, the client does so. After step 411, the client continues in step 403.

In step 412, the server adds a record for the DeviceID specified by the client for the user, as identified by the user's LoginID. In step 413, the server creates a ServiceSecret for the device and stores it in the device record created in step 412. In step 413, the server generates a ServiceSessionKey for the session, using the ServiceSecret generated in step 413. In step 415, the server regenerates the ClientBinding. In step 416, the server generates a digest of the transaction Salt as encrypted using the TemporaryPassword. In step 417, the server sends to the client the ClientBinding regenerated in step 415, together with a hash on the ServiceSessionKey, a CommonName, and a DefaultPolicy. In step 418, the client, after receiving the information sent by the server in step 417, stores this information and uses the ServiceSessionKey to encrypt the remainder of the session with the server as follows below. Steps 419-430 together comprise a process for generating a client data certificate. In step 419, the client creates an asymmetric key pair for the device, the keys of which are called DevicePrivateKey and DevicePublicKey. In step 420, the client uses the key pair created in step 419 and the CommonName to create a certificate sign in request that is encrypted with the ServiceSessionKey. In step 421, the client sends the encrypted request from step 420 along with the ClientBinding to the server. In step 422, upon receiving information sent by the client in step 421, the server validates the ClientBinding. In step 423, the server retrieves the ServiceSessionKey for the user. In step 424, the server uses a ServiceSessionKey to decrypt the received request. In step 425, the server regenerates the ClientBinding and the Certificate. In step 426, the server generates a CertPKEncryptionKey encryption key to be used by the client to encrypt the private key and device certificate on the client. In step 427, the server uses the ServiceSessionKey to encrypt the private key and certificate along with the Salt. In step 428, the server sends to the client the ClientBinding, together with the encrypted combination of device certificate, certificate encryption key, and Salt. In step 429, the server stores the certificate encryption key in the device record. In step 430 the client, upon receiving the information sent by the server in step 428, decrypts the combination of device certificate, certificate encryption key, and Salt. In step 431, the client uses the certificate encryption key to encrypt the device certificate and device private key and stores these as security objects on the device.

Steps 432-433 together comprise a process for initiating two-way SSL. In step 432, the client initiates two-way SSL with the server using the device certificate and private key decrypted in step 430. In step 433, the server authenticates the device based on the client certificate.

Steps 434-437 together comprise a process for setting up a user password. In step 434, the client prompts the user to enter a temporary password prescribed by the operator of the system, as well as a user-selected password to use on an on-going basis. In step 435, the client generates two password hashes. In step 436, the client sends to the server the second hash encrypted by the ServiceSessionKey, together with the ClientBinding. In step 437, after receiving the information sent by the client in step 436, the server generates a third password hash and stores it.

Steps 438-443 collectively comprise a process for setting up data encryption keys to be used to store data securely on the client. In step 438, the client generates a data encryption key for the device. In step 439, the client encrypts the data encryption key generated in step 438 with the DevicePrivateKey to obtain an RSAPrivKeyEncryptedDataEncryptionKey. In step 440, the client sends to the server the ClientBinding, together with a combination of the RSAPrivKeyEncryptedDataEncryptionKey and the DataEncryptionKey, a combination encrypted with the ServiceSessionKey. In step 441, the server, upon receiving the information sent by the client in step 440, stores the data encryption key in the device record for the device. In step 442, the client uses the data encryption key to encrypt secured data objects stored locally in the client. In step 443, the client disconnects the SSL session. After step 443, these steps conclude.

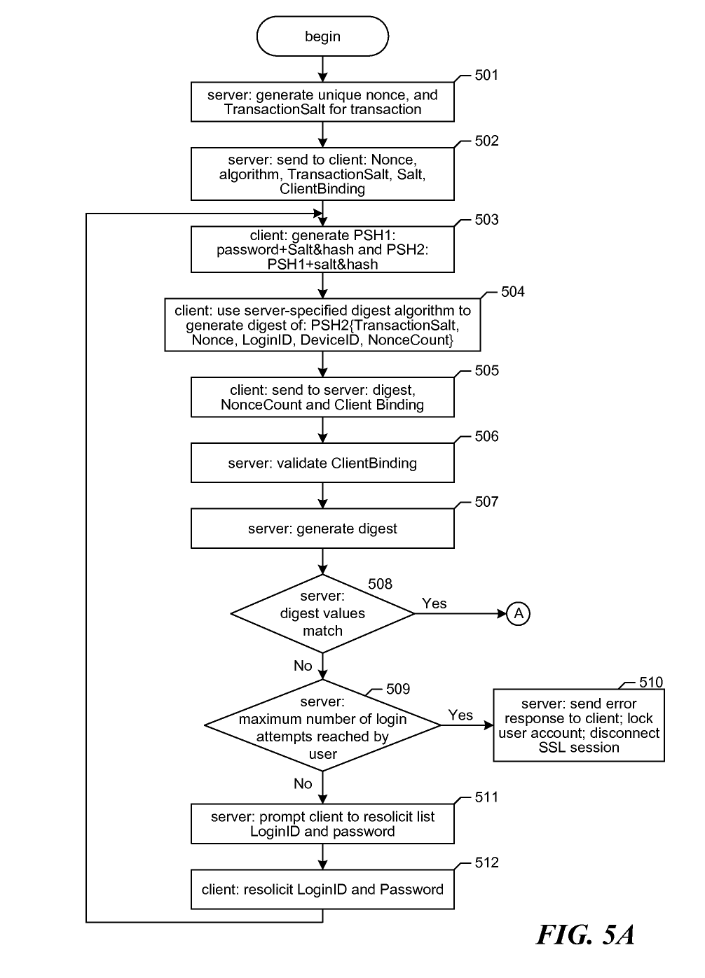

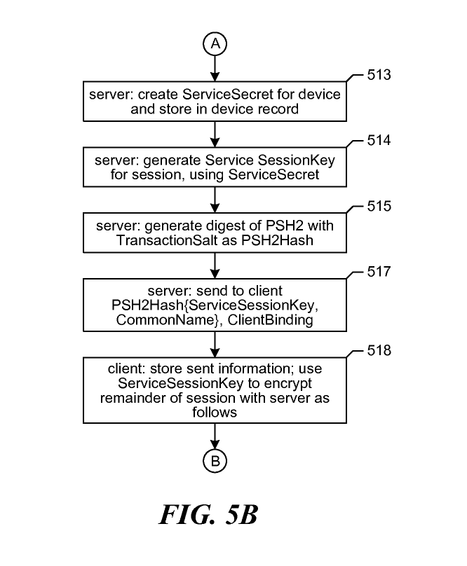

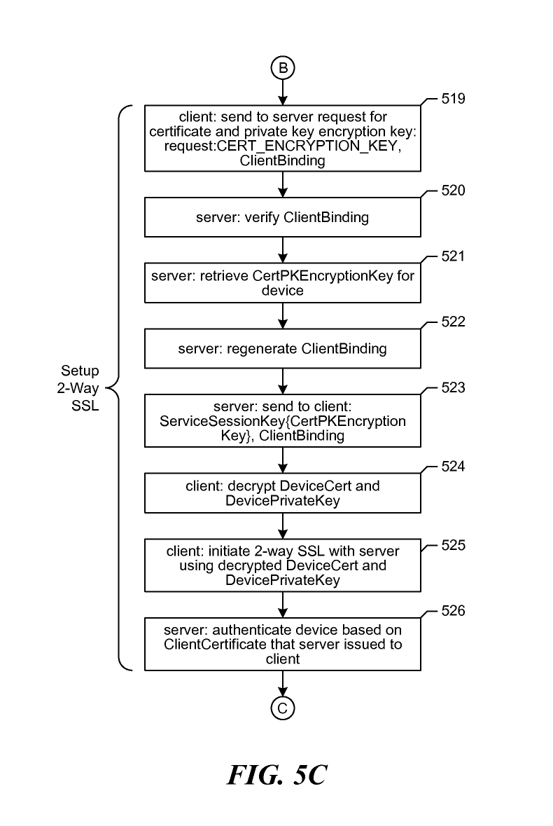

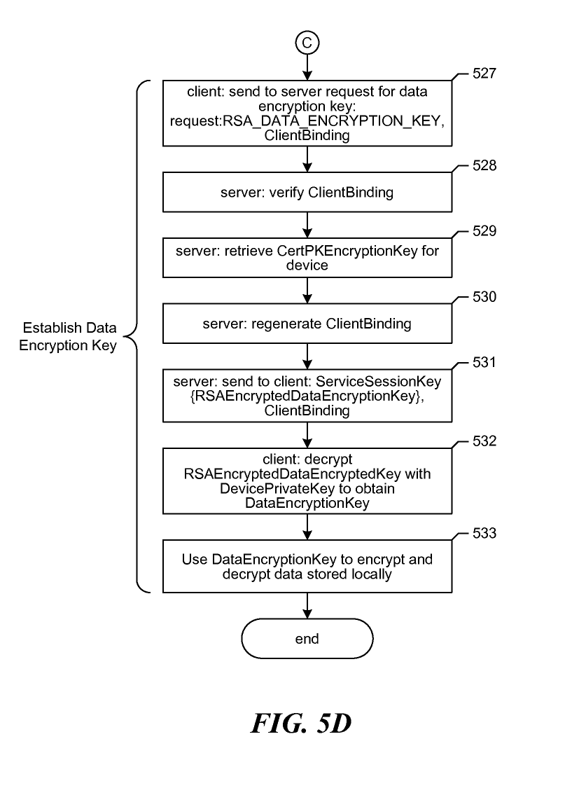

FIGS. 5A-5D collectively comprise a flow diagram showing steps typically performed by the system in order to perform the UserLogin routine. Steps 501-502 parallel steps 401-402 shown in FIG. 4A and discussed above. In step 503, the client generates two password hashes on the password provided by the user. In step 504, the client uses the digest algorithms specified by the sever in step 502 to generate a digest of the following as encrypted by the second password hash: the Salt, the Nonce, the user's LoginID, the DeviceID, the NonceCount. At step 505, the client sends to the server the digest value determined at step 504 and the NonceCount, and ClientBinding. In step 506, the server, upon receiving the information sent by the client in step 505, validates the ClientBinding. At step 507, the server regenerates the same digest generated by the client in step 504. Steps 508-512 parallel steps 407-411 shown in FIG. 4A and discussed above. Steps 513-514 parallel steps 413-414 shown in FIG. 4B and discussed above. In step 515, the server generates a digest of the second password hash using the Salt. In step 516, the server sends to the client a hash of the ServiceSessionKey. In step 517, the server sends to the client a hash on the ServiceSessionKey together with the CommentName and the DefaultPolicy. The hash is accompanied by the ClientBinding.

Steps 519-526 collectively comprise a process that sets up two-way SSL. In step 519, the client sends to the server a request for a certificate and a private encryption key. In step 520, the server, upon receiving the information sent by the client sent in 519, verifies the ClientBinding enclosed with the request. In step 521, the server retrieves the certificate encryption key for the device. In step 522, the server regenerates the ClientBinding. In step 523, the server sends to the client the regenerated ClientBinding, together with the certificate encryption key encrypted with the service session key. In step 524, the client, upon receiving information sent by the server in step 523, decrypts the device certificate and device private key. In step 525, the client initiates two-way SSL with the server using the decrypted device certificate and device private key. In step 526, the server authenticates the device based on the client certificate that the server issued to the client.

Steps 527-533 collectively comprise a process for establishing a data encryption key used to protect data stored on the device. In step 527, the client sends to the server a request for data encryption key. Steps 528-530 parallel steps 520-522 shown in this diagram and described above. In step 523, the server sends to the client the ClientBinding, along with the data encryption key encrypted using the ServiceSessionKey. In step 532, the client, upon receiving the information sent by the server in step 531, decrypts the data encryption key. In step 533, the client uses the data encryption key to encrypt and decrypt data stored on the device. After step 533, these steps conclude.

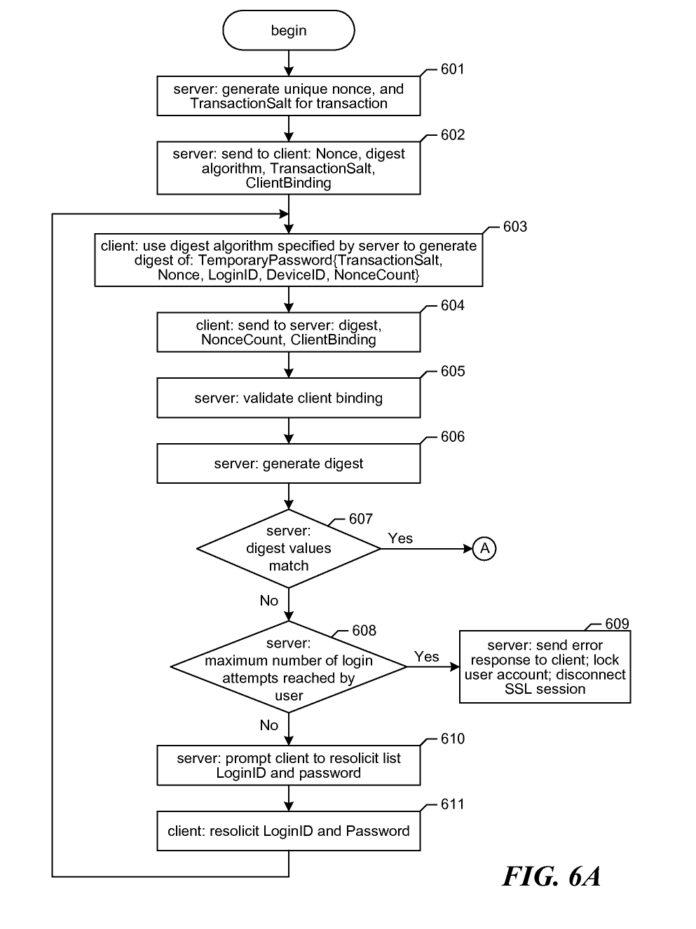

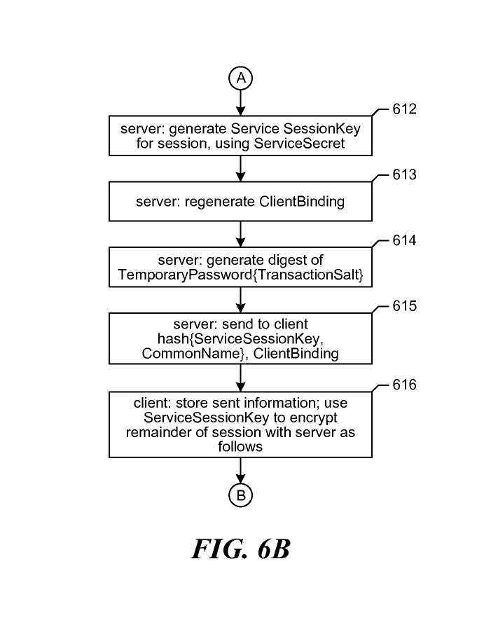

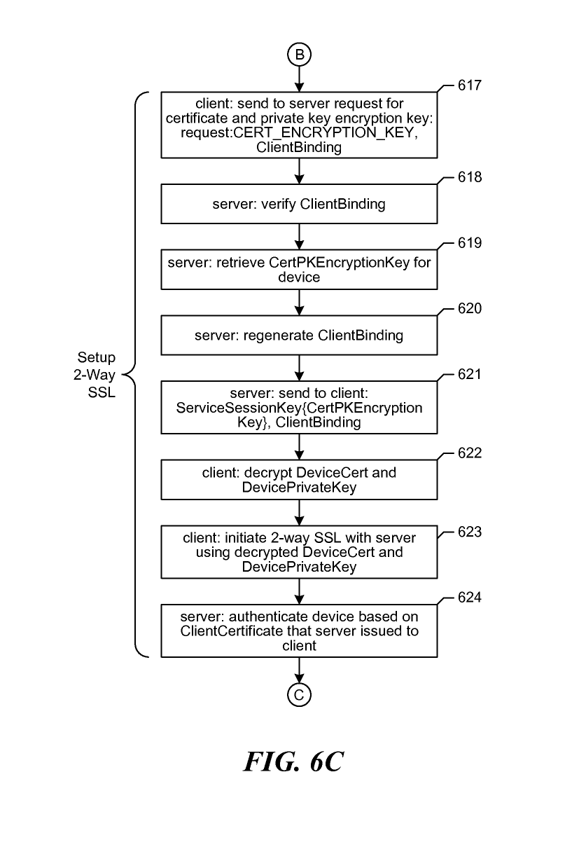

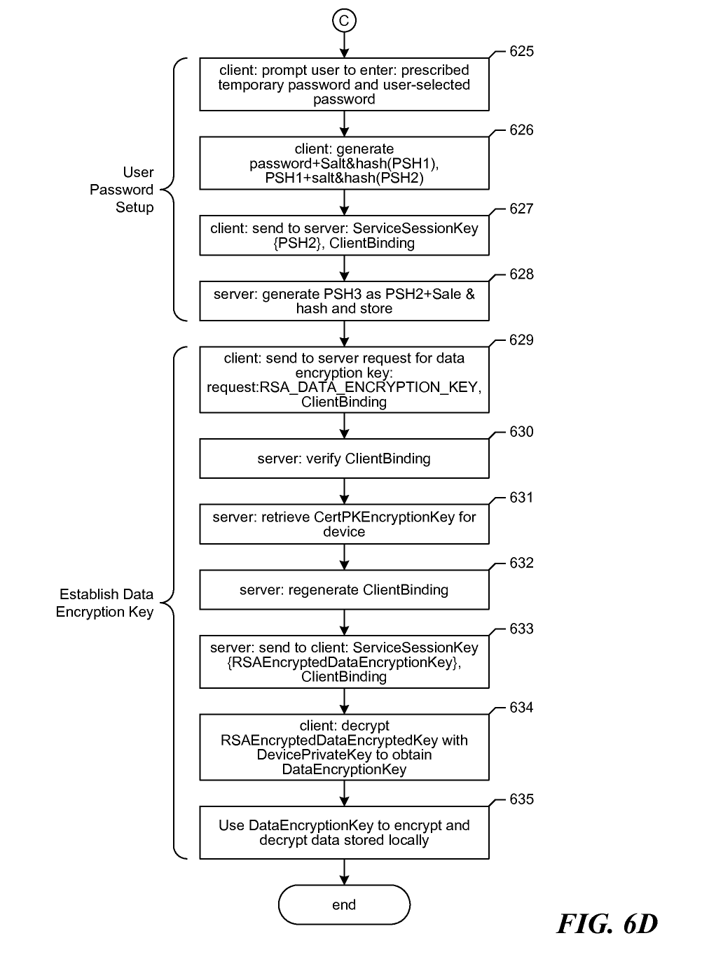

FIG. 6A-6D collectively comprise a flow diagram showing steps typically performed by the system in order to perform an AccountReactivationFromAddedDevice routine. Steps 601-611 are parallel to steps 401-411 shown in FIG. 4A and described above. Steps 612-616 parallel steps 414-418 shown in FIG. 4B and discussed above. Steps 617-624 parallel steps 519-526 shown in FIG. 5C and discussed above; these steps make up a process for establishing two-way SSL. Steps 625-628 parallel steps 434-437 shown in FIG. 4D and described above; these steps make up a process for setting up the user password. Steps 629-635 parallel steps 527-533 shown in FIG. 5D and discussed above; these steps make up a process for establishing a data encryption key. After step 635, these steps conclude.

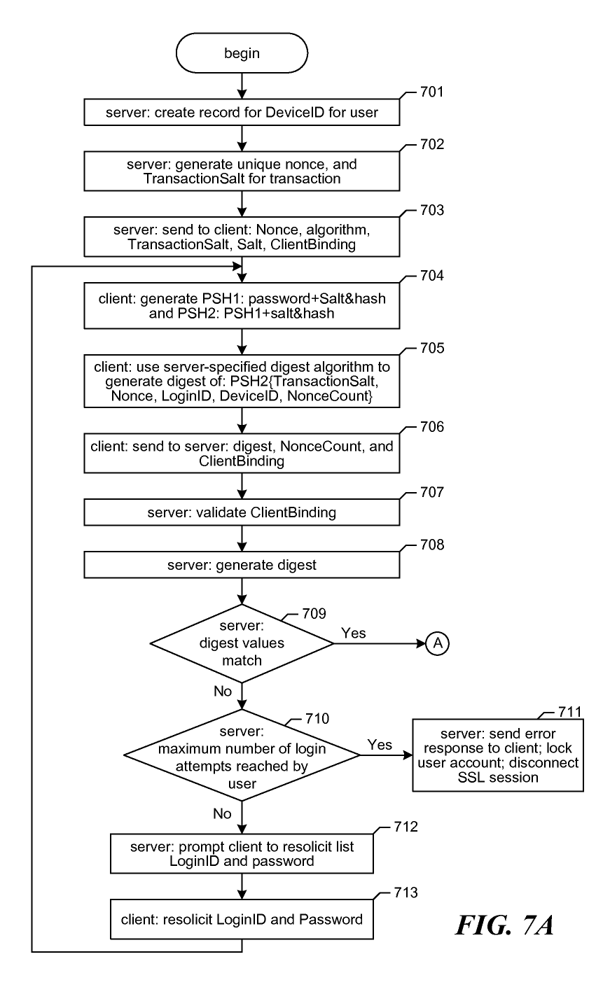

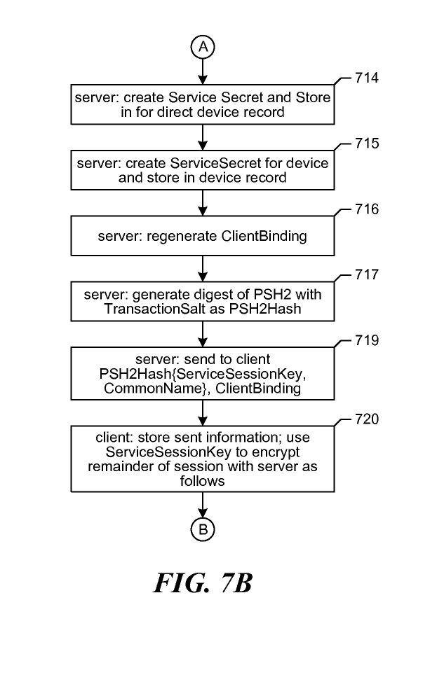

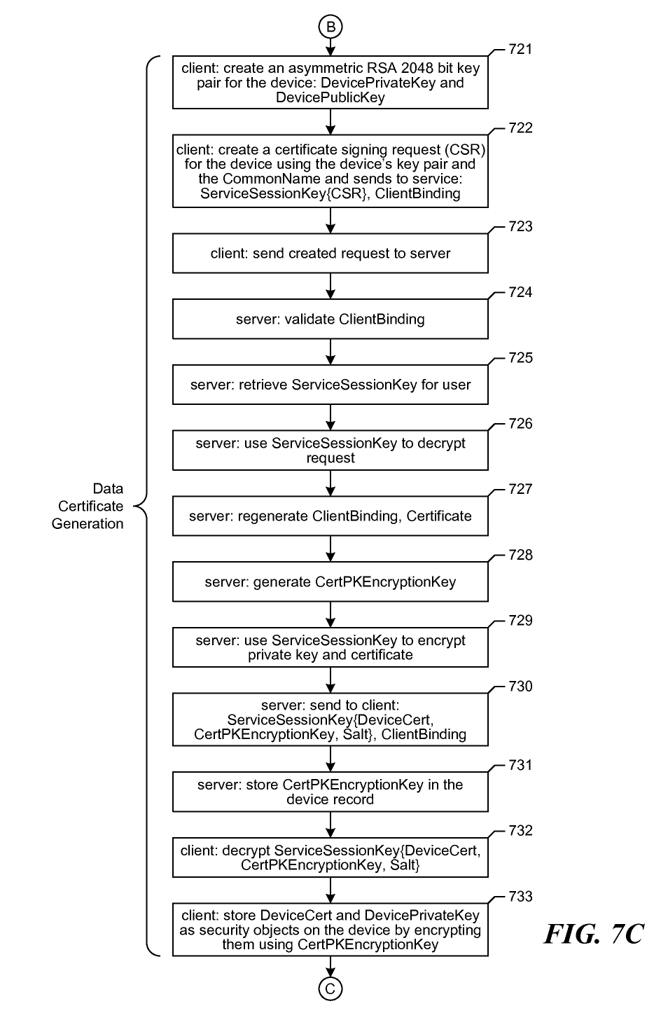

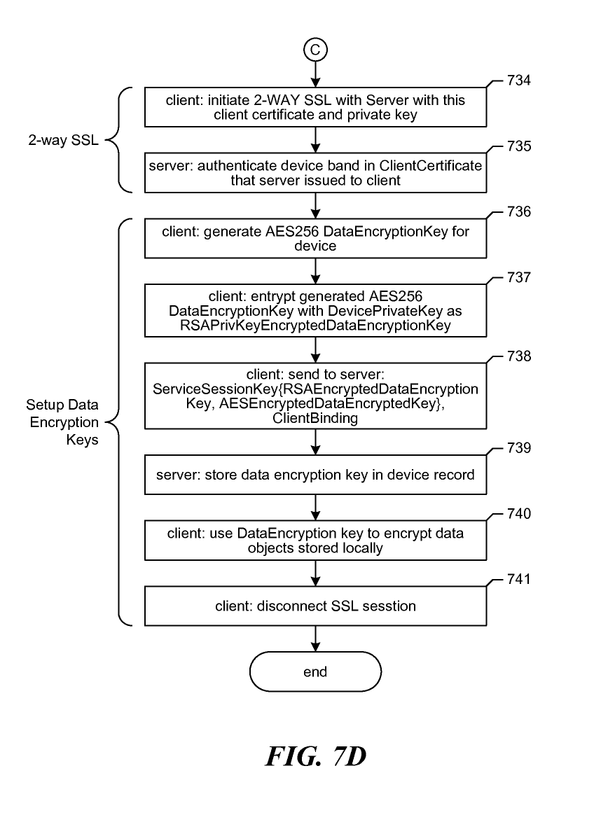

FIGS. 7A-7D together comprise a flow diagram showing steps typically performed by the system as part of performing an AddDevice routine. At step 701, the server creates a record for the DeviceID for the user. Steps 702-713 parallel steps 501-512 shown in FIG. 5A and described above. Steps 714-720 parallel steps 612-616 shown in FIG. 6B and described above. Steps 721-733 parallel steps 419-431 shown in FIG. 4C and described above; these steps make up a process for data certificate generation. Steps 734-735 parallel steps 432-433 shown in FIG. 4D and described above; these steps make up a process for establishing two-way SSL. Steps 736-741 parallel steps 438-443 shown in FIG. 4D and described above; these steps make up a process for setting up data encryption keys. After step 741, these steps conclude.

It will be appreciated by those skilled in the art that the above-described system may be straightforwardly adapted or extended in various ways. While the foregoing description makes reference to particular embodiments, the scope of the invention is defined solely by the claims that follow and the elements recited therein.

I claim:

1. A data security method in a mobile device, the method comprising:
transmitting first data from the mobile device to a server;
receiving second data from the server that is responsive to the first data; and
using the received second data together with third data stored on the mobile device to decrypt fourth data stored in encrypted form on the mobile device to obtain fifth data, such that, prior to receiving the second data, the state of the mobile device is inadequate to decrypt the fourth data.

2. The data security method of claim 1, further comprising acting on the fifth data.

3. The data security method of claim 1, further comprising displaying the fifth data.

4. The data security method of claim 1, further comprising modifying the fifth data.

5. The data security method of claim 1, further comprising transmitting the fifth data beyond the mobile device.

6. The data security method of claim 1 wherein the first data includes user authentication credentials.

7. The data security method of claim 6, further comprising, before transmitting the first data, negotiating with a server the user authentication credentials using a single-use activation code provided via the mobile device.

8. The data security method of claim 1 wherein the first data includes a device certificate stored in the mobile device.

9. The data security method of claim 1 wherein the first data includes information relating to a trustedness assessment of the mobile device.

10. The data security method of claim 1, further comprising:
using the second data together with the third data to encrypt sixth data to obtain seventh data; and
storing the seventh data in the device.

11. The data security method of claim 1 wherein the second data is received using a standards-based secure data transmission protocol and subjected to decryption specified by the protocol upon receipt.

12. The data security method of claim 11 wherein, before being used together with the third data to decrypt fourth data, the second data is further decrypted using a transmission key.

13. The data security method of claim 12 wherein the transmission key is unique among mobile devices including the mobile device that are connecting to the server.

14. The data security method of claim 12 wherein the transmission key varies over time.

15. The data security method of claim 12 wherein the transmission key has no relationship to any hardware-level identifier of the mobile device.

16. One or more instances of computer-readable media collectively having contents configured to cause a mobile device to perform a data security method, the method comprising:
transmitting first data from the mobile device to a server;
receiving second data from the server that is responsive to the first data; and
using the received second data together with third data stored on the mobile device to decrypt fourth data stored in encrypted form on the device to obtain fifth data, such that, prior to receiving the second data, the state of the mobile device is inadequate to decrypt the fourth data.

17. The instances of computer-readable media of claim 16, the method further comprising acting on the fifth data.

18. The instances of computer-readable media of claim 16, the method further comprising displaying the fifth data.

19. instances of computer-readable media of claim 16, the method further comprising modifying the fifth data.

20. The instances of computer-readable media of claim 16, the method further comprising transmitting the fifth data beyond the mobile device.

21. The instances of computer-readable media of claim 16 wherein the first data includes user authentication credentials.

22. The instances of computer-readable media of claim 21, further comprising, before transmitting the first data, negotiating with a server the user authentication credentials using a single-use activation code provided via the mobile device.

23. The instances of computer-readable media of claim A16 wherein the first data includes a device certificate stored in the mobile device.

24. The instances of computer-readable media of claim 16 wherein the first data includes information relating to a trusted nurse assessment of the mobile device.

25. The instances of computer-readable media of claim 16, the method further comprising:
using the second data together with the third data to encrypt sixth data to obtain seventh data; and
storing the seventh data in the device.

26. The instances of computer-readable media of claim 16 wherein the second data is received via an SSL connection, and subjected to SSL decryption upon receipt.

27. The instances of computer-readable media of claim 26 wherein, before being used together with the third data to decrypt fourth data, the second data is further decrypted using a transmission key.

28. The data security method of claim 27 wherein the transmission key is unique among mobile devices including the mobile device that are connecting to the server.

29. The instances of computer-readable media of claim 27 wherein the transmission key varies over time.

30. The instances of computer-readable media of claim 27 wherein the transmission key has no relationship to any hardware-level identifier of the mobile device.

31. A data security method in a server, the method comprising:
receiving first data from a mobile device;
in response to receiving the first data, transmitting to the mobile device second data usable by the mobile device together with third data stored on the mobile device to decrypt fourth data stored in encrypted form on the mobile device to obtain fifth data, such that, prior to receiving the second data, the state of the mobile device is inadequate to decrypt the fourth data.

32. The data security method of claim 31 wherein the first data includes user authentication credentials.

33. The data security method of claim 32, further comprising, before transmitting the first data, negotiating with the mobile device the user authentication credentials using a single-use activation code provided via the mobile device.

34. The data security method of claim 31 wherein the first data includes a device certificate stored in the mobile device.

35. The data security method of claim 31 wherein the first data includes information relating to a trustedness assessment of the mobile device.

36. The data security method of claim 31 wherein the second data is transmitted via a standards-based secure data transmission protocol, and subjected to encryption specified by the protocol before transmission.

37. The data security method of claim 36 wherein, before being subjected to encryption specified by the protocol, the second data is encrypted using a transmission key.

38. The data security method of claim 37 wherein the transmission key is unique among mobile devices including the mobile device that are connecting to the server.

39. The data security method of claim 37 wherein the transmission key varies over time.

40. The data security method of claim 37 wherein the transmission key has no relationship to any hardware-level identifier of the mobile device.

41. One or more instances of computer-readable media collectively having contents configured to cause a server to perform a data security method, the method comprising:
receiving first data from a mobile device;
in response to receiving the first data, transmitting to the mobile device second data usable by the mobile device together with third data stored on the mobile device to decrypt fourth data stored in encrypted form on the mobile device to obtain fifth data, such that, prior to receiving the second data, the state of the mobile device is inadequate to decrypt the fourth data.

42. The data security method of claim 31 wherein the first data includes user authentication credentials.

43. The data security method of claim 42, the method further comprising, before transmitting the first data, negotiating with the mobile device the user authentication credentials using a single-use activation code provided via the mobile device.

44. The data security method of claim 41 wherein the first data includes a device certificate stored in the mobile device.

45. The data security method of claim 41 wherein the first data includes information relating to a trustedness assessment of the mobile device.

46. The data security method of claim 41 wherein the second data is transmitted via an SSL connection, and subjected to SSL encryption before transmission.

47. The data security method of claim 46 wherein, before being subjected to SSL encryption, the second data is encrypted using a transmission key.

48. The data security method of claim 47 wherein the transmission key is unique among mobile devices including the mobile device that are connecting to the server.

49. The data security method of claim 47 wherein the transmission key varies over time.

50. The data security method of claim 47 wherein the transmission key has no relationship to any hardware-level identifier of the mobile device.

51. One or more instances of computer-readable media directly connected to a mobile device that collectively contain a secure data store data structure, the data structure comprising:
user data that has been encrypted using an encryption key, no computer-readable media directly connected to the mobile device containing the encryption key in any form; and
a secondary key usable to decrypt the encryption key if received in encrypted form from a device external to the mobile device,
such that, if the mobile device receives the encryption key in encrypted form, the mobile device can use the secondary key to decrypt the encryption key, then in turn using encryption key to decrypt the user data.
